(19) United States
(12) Patent Application Publication
(10) Pub. No.: US 2026/0141221 A1
(43) Pub. Date: May 21, 2026

(54) CLASSIFICATION DEVICE BASED ON FIXED NON-NEGATIVE ORTHOGONAL CLASSIFIER AND CONTROL METHOD THEREOF

(71) Applicant: Gwangju Institute of Science and Technology, Gwangju (KR)

(72) Inventors: Ho Yong KIM, Gwangju (KR); Kang Il KIM, Gwangju (KR)

(73) Assignee: Gwangju Institute of Science and Technology, Gwangju (KR)

(21) Appl. No.: 19/351,933

(22) Filed: Oct. 7, 2025

(30) Foreign Application Priority Data
Nov. 20, 2024 (KR) 10-2024-0165913

(51) Int. Cl. G06N 3/047; G06N 3/08

(52) U.S. Cl. CPC G06N 3/047; G06N 3/08

(57) ABSTRACT

A classification device based on a fixed non-negative orthogonal classifier, and a control method thereof. A classifier in an artificial neural network, and a method and device for generating a fixed non-negative orthogonal classifier, by fixing all class vectors in a non-negative orthogonal form, and, by using Softmax masking that reduces inter-class interference through neural collapse fixed at the origin and feature dimension separation caused thereby, and by using arc-mixup, to solve problems of continual learning and imbalanced learning.

### CROSS REFERENCE TO RELATED APPLICATION

The present application claims priority to Korean Patent Application No. 10-2024-0165913 filed on Nov. 20, 2024, the entire contents of which are hereby incorporated by reference.

### STATEMENT REGARDING PRIOR DISCLOSURES BY THE INVENTOR OR A JOINT INVENTOR

Prior disclosure related to the present application was made by inventors of the present application in journal paper entitled “Fixed Non-negative Orthogonal Classifier: Inducing Zero-mean Neural Collapse with Feature Dimension Separation” on Jan. 16, 2024. A copy of the journal paper is provided on a concurrently filed Information Disclosure Statement.

### BACKGROUND

### Field of the Invention

The present invention relates to a classification device based on a fixed non-negative orthogonal classifier, and a control method thereof. More specifically, the present invention relates to a classifier in an artificial neural network, and relates to a method and device for generating a fixed non-negative orthogonal classifier, by fixing all class vectors in a non-negative orthogonal form, and, by using Softmax masking that reduces inter-class interference through neural collapse fixed at the origin and feature dimension separation caused thereby, and by using arc-mixup, to solve problems of continual learning and imbalanced learning.

### Description of the Related Art

Generally, classifier learning in an artificial neural network is performed through learnable class weight vectors. An artificial neural network learns information from input data through a neural network, and represents each data in a representation space. Through such a series of representation learning processes, the learned representation is classified for each class through a classifier, and the performance in fields such as image classification, which is a core technology in the AI field, is determined according to how accurately the classifier is learned.

A fixed classifier is a method of fixing class vectors of such a classifier, which reduces the computational load by reducing the number of learnable parameters of the artificial neural network while maintaining performance, and this may increase computational efficiency in a large language model, in which the number of learnable parameters is a major problem.

Neural Collapse (NC) is a phenomenon discovered by analyzing a training tendency when training a classification model based on an artificial neural network, and are a theory that “in a completely trained classification model, a feature vector and a class vector of the classifier match, and their shape forms a simplex Equiangular Tight Frame (simplex ETF).”

A simplex Equiangular Tight Frame classifier (ETF classifier), which is a prior art is a method in which the neural collapse theory is applied to a fixed classifier, which solves the problem of continual learning and imbalanced learning by fixing the classifier in a simplex equiangular tight frame. However, a limitation exists in that it cannot explain collapse phenomena in classifiers fixed in other forms.

### Documents of Related Art

(Non-patent Document 1) E. Hoffer, I. Hubara and D. Soudry, Fix your classifier: the marginal value of training the last weight layer, The Sixth International Conference on Learning Representations, 2018
(Non-patent Document 2) V. Papyan, X. Y. Han and D. L. Donoho, Prevalence of neural collapse during the terminal phase of deep learning training, In Proceedings

### SUMMARY

The present invention is directed to providing a fixed non-negative orthogonal classifier in which non-negativity and orthogonality are added to a fixed classifier.

More specifically, the present invention is to add non-negativity and orthogonality to a fixed classifier, explain neural collapse phenomena in a fixed classifier of a form other than a simplex equiangular tight frame, and enhance Softmax masking using feature dimension separation generated therefrom, and enable implementation of arc-mixup, thereby improving performance in continual learning and imbalanced learning.

Further, the present invention is directed to providing a fixed non-negative orthogonal classifier and a mask-weighted Softmax device in continual learning using the feature dimension separation effect of the fixed non-negative orthogonal classifier.

Furthermore, the present invention is directed to providing arc-mixup and a mini-batch unit feature masking device in imbalanced learning using the feature dimension separation effect of the fixed non-negative orthogonal classifier.

To achieve the aforementioned objects, there is provided a control method of a classification device based on a fixed non-negative orthogonal classifier, according to the present invention, the control method may include: processing input data as an input of a neural network; acquiring a feature vector for the input data from an encoder of the neural network; inputting the feature vector to a fixed non-negative orthogonal classifier having non-negativity and orthogonality; acquiring a class probability value for the input data from the fixed non-negative orthogonal classifier; and specifying a final predicted class for the input data by using the class probability value.

Further, the fixed non-negative orthogonal classifier may have the non-negativity, in which all elements of a matrix have non-negative values, and the orthogonality, in which a matrix multiplication of the matrix and a transposed matrix of the matrix is an identity matrix.

Further, the fixed non-negative orthogonal classifier may be composed of class vectors that are preset to satisfy the non-negativity and the orthogonality.

Further, the acquiring of the class probability value may include predicting the class probability value through feature dimension separation of the fixed non-negative orthogonal classifier and acquiring the class probability value predicted from the fixed non-negative orthogonal classifier.

Further, the feature dimension separation may be a characteristic in which elements of each class do not overlap in dimension with elements of remaining other class vectors, with respect to the preset class vectors.

Further, the fixed non-negative orthogonal classifier may satisfy a zero-mean neural collapse (ZNC), and set a center of the class vectors to an origin instead of a mean of each class.

Further, the neural network may perform training by using at least one training algorithm defined based on the fixed non-negative orthogonal classifier.

Further, the neural network may perform training by using a loss function defined from the class probability value.

Meanwhile, there is provided a classification device based on a fixed non-negative orthogonal classifier, according to the present invention. The classification device may include a memory and at least one processor, in which the memory and the processor may cooperate to: process input data as an input to a neural network; acquire a feature vector for the input data from an encoder of the neural network; input the feature vector to a fixed non-negative orthogonal classifier having non-negativity and orthogonality; acquire a class probability value for the input data from the fixed non-negative orthogonal classifier; and specify a final predicted class for the input data by using the class probability value.

Meanwhile, there is provided a program stored in a computer-readable recording medium, the program being executed by one or more processes in an electronic device, in which the program may include instructions to perform: processing input data as an input to a neural network; acquiring a feature vector for the input data from an encoder of the neural network; inputting the feature vector to a fixed non-negative orthogonal classifier having non-negativity and orthogonality; acquiring a class probability value for the input data from the fixed non-negative orthogonal classifier; and specifying a final predicted class for the input data by using the class probability value.

As described above, according to the classification device based on the fixed non-negative orthogonal classifier and control method thereof according to the present invention, it is possible to alleviate inter-class interference by generating a feature dimension separation phenomenon through a fixed non-negative orthogonal classifier in which non-negativity and orthogonality are added.

In addition, according to the classification device based on the fixed non-negative orthogonal classifier and control method thereof according to the present invention, Softmax masking using the fixed non-negative orthogonal classifier may improve the training performance of a model (or neural network) in continual learning by weakening the catastrophic forgetting effect.

Further, according to the classification device based on the fixed non-negative orthogonal classifier and control method thereof according to the present invention, the application of arc-mixup and mini-batch unit masking using the fixed non-negative orthogonal classifier may improve the performance of a model (or neural network) in imbalanced learning by alleviating inter-class interference and reinforcing balanced decision boundary learning. This may contribute to enabling the model to efficiently learn more balanced decision boundaries in an imbalanced dataset.

### BRIEF DESCRIPTION OF THE DRAWINGS

FIG. 1 is a conceptual diagram for explaining a neural collapse phenomenon that occurs according to the type of classifier.

FIG. 2 is a conceptual diagram for explaining a classification device based on a fixed non-negative orthogonal classifier according to the present invention.

FIG. 3 is a flowchart for explaining a control method of a classification device based on a fixed non-negative orthogonal classifier according to the present invention.

FIG. 4 and FIG. 5 are conceptual diagrams for explaining an algorithm related to training of an artificial neural network including a fixed non-negative orthogonal classifier according to the present invention.

FIG. 6 is a set of equations for explaining an algorithm related to training of an artificial neural network including a fixed non-negative orthogonal classifier according to the present invention.

FIGS. 7 and 8 are tables illustrating an embodiment of training results of an artificial neural network including a fixed non-negative orthogonal classifier according to the present invention.

FIG. 9 is a block diagram illustrating an embodiment of a computing system in which the present invention can be implemented.

FIGS. 10 and 11 are block diagrams illustrating an embodiment of a computing device according to the present invention.

### DETAILED DESCRIPTION

Hereinafter, exemplary embodiments disclosed in the present specification will be described in detail with reference to the accompanying drawings. The same or similar constituent elements are assigned with the same reference numerals regardless of reference numerals, and the repetitive description thereof will be omitted. The suffixes “module”, “unit”, “part”, and “portion” used to describe constituent elements in the following description are used together or interchangeably in order to facilitate the description, but the suffixes themselves do not have distinguishable meanings or functions. In addition, in the description of the exemplary embodiment disclosed in the present specification, the specific descriptions of publicly known related technologies will be omitted when it is determined that the specific descriptions may obscure the subject matter of the exemplary embodiment disclosed in the present specification. In addition, it should be interpreted that the accompanying drawings are provided only to allow those skilled in the art to easily understand the embodiments disclosed in the present specification, and the technical spirit disclosed in the present specification is not limited by the accompanying drawings, and includes all alterations, equivalents, and alternatives that are included in the spirit and the technical scope of the present invention.

The terms including ordinal numbers such as “first,” “second,” and the like may be used to describe various constituent elements, but the constituent elements are not limited by the terms. These terms are used only to distinguish one constituent element from another constituent element.

When one constituent element is described as being “coupled” or “connected” to another constituent element, it should be understood that one constituent element can be coupled or connected directly to another constituent element, and an intervening constituent element can also be present between the constituent elements. When one constituent element is described as being “coupled directly to” or “connected directly to” another constituent element, it should be understood that no intervening constituent element exists between the constituent elements.

Singular expressions include plural expressions unless clearly described as different meanings in the context.

In the present application, it should be understood that terms “including” and “having” are intended to designate the existence of characteristics, numbers, steps, operations, constituent elements, and components described in the specification or a combination thereof, and do not exclude a possibility of the existence or addition of one or more other characteristics, numbers, steps, operations, constituent elements, and components, or a combination thereof in advance.

The present invention relates to a classification device based on a fixed non-negative orthogonal classifier, and a control method thereof. The classification device based on a fixed non-negative orthogonal classifier according to the present invention may be a device for providing a fixed non-negative orthogonal classifier in which non-negativity and orthogonality are added to a fixed classifier. Accordingly, the present invention may also be referred to as a method and device for generating a fixed non-negative orthogonal classifier, by fixing all class vectors in a non-negative orthogonal form, and, by using Softmax masking that reduces inter-class interference through neural collapse fixed at the origin and feature dimension separation caused thereby, and by using arc-mixup, to solve problems of continual learning and imbalanced learning.

In this regard, an artificial neural network and/or a classification model based on the artificial neural network may be configured with an encoder that generates features from input samples and a classifier for classes included in a dataset.

Classifier learning in a neural network may be performed through learnable class weight vectors. The neural network may learn information from input data and represent each data in a representation space. Through such a series of representation learning processes, the learned representation is classified for each class through a classifier, and the performance in fields such as image classification, which is a core technology in the AI field, may be determined according to how accurately the classifier is learned.

The fixed classifier, as described above, is a method of fixing class vectors of such a classifier, which reduces the computational load by reducing the number of learnable parameters of the neural network while maintaining performance, and this may increase computational efficiency in a large language model, in which the number of learnable parameters is a major problem.

Meanwhile, neural collapse (NC) is a phenomenon discovered by analyzing a training tendency when training a classification model based on a neural network, and are a theory that “in a completely trained classification model, a feature vector and a class vector of the classifier match, and their shape forms a simplex Equiangular Tight Frame (simplex ETF).”

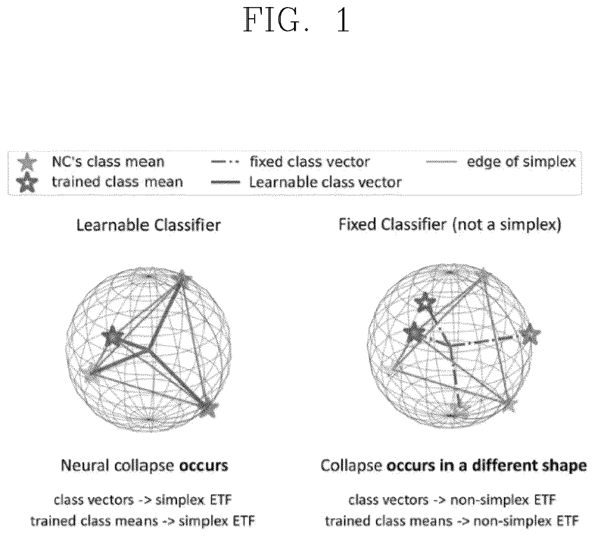

In this regard, as illustrated in FIG. 1, a conventional simplex Equiangular Tight Frame classifier (ETF classifier) is a method in which the neural collapse theory is applied to a fixed classifier, which solves the problem of continual learning and imbalanced learning by fixing the classifier in a simplex equiangular tight frame. However, a limitation exists in that it cannot explain collapse phenomena in classifiers fixed in other forms.

Accordingly, when a fixed classifier is fixed in a structure other than a simplex equiangular tight frame form, research is required on whether neural collapse may occur in a different form (or how the collapse phenomenon between class means and class weight vectors occurs), and to solve this, the present invention proposes a fixed non-negative orthogonal classifier in which two characteristics, non-negativity and orthogonality, are added to a fixed classifier.

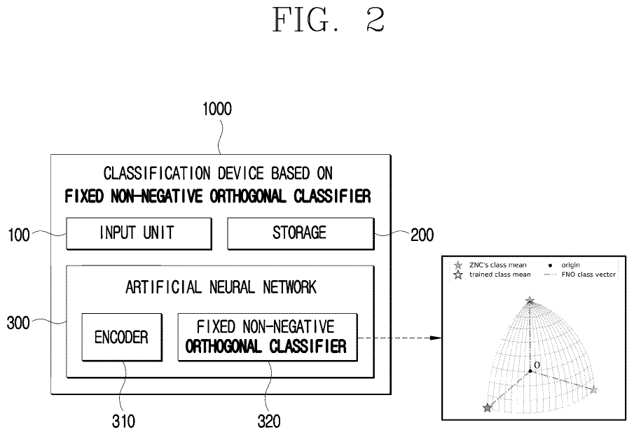

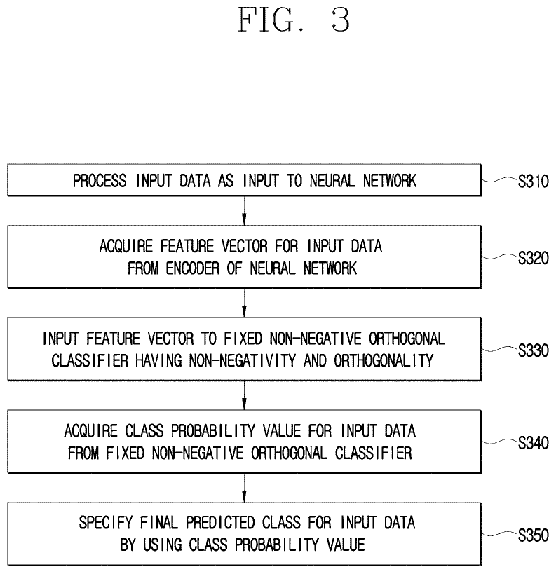

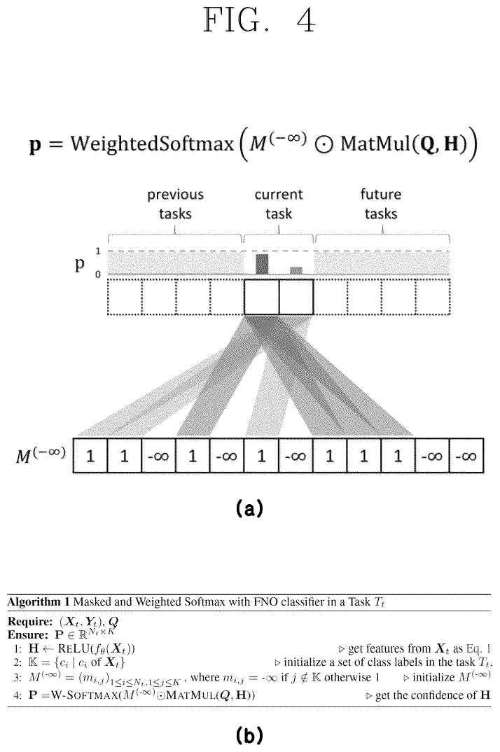

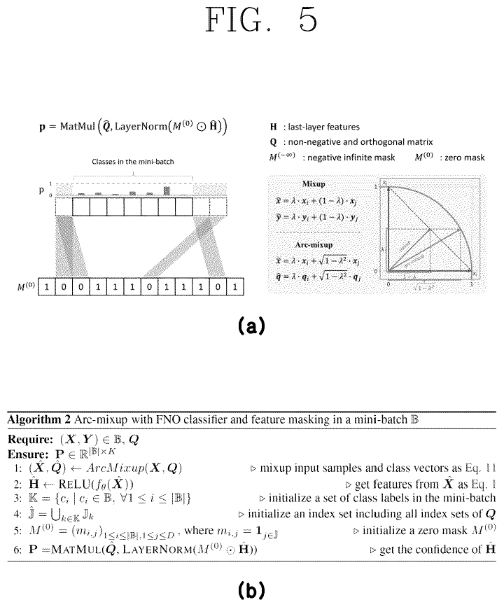

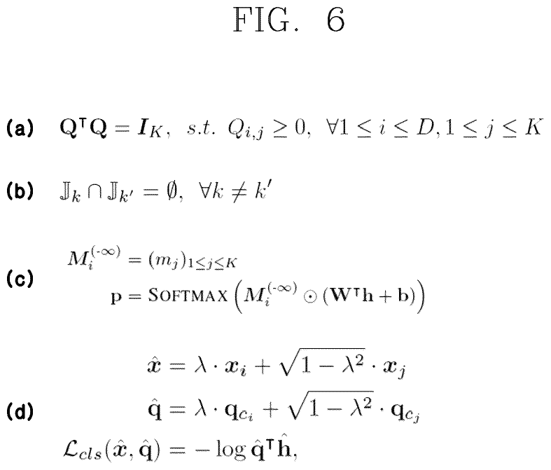

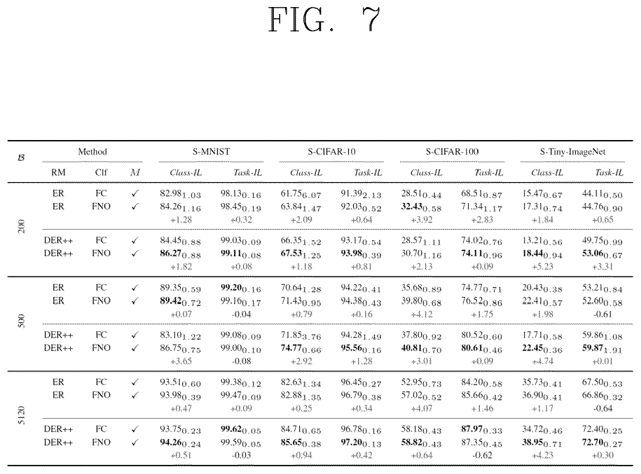

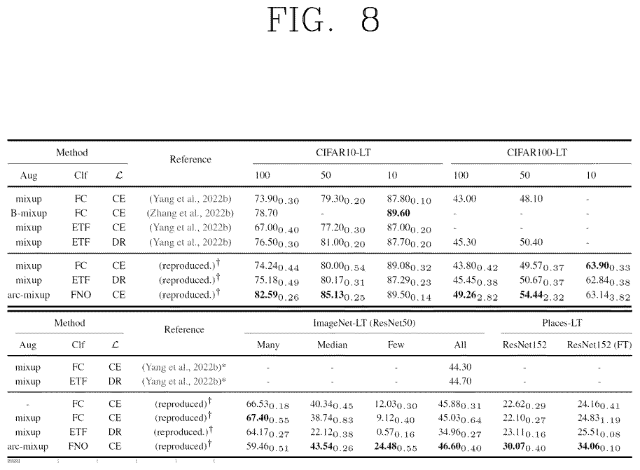

Hereinafter, the present invention will be described in more detail with reference to the accompanying drawings. FIG. 2 is a conceptual diagram for explaining a classification device based on a fixed non-negative orthogonal classifier according to the present invention. FIG. 3 is a flowchart for explaining a control method of a classification device based on a fixed non-negative orthogonal classifier according to the present invention, and FIGS. 4A, 4B, 5A, and 5B are conceptual diagrams for explaining an algorithm related to training of an artificial neural network including a fixed non-negative orthogonal classifier according to the present invention. Further, FIGS. 6A to 6D are a set of equations for explaining an algorithm related to training of an artificial neural network including a fixed non-negative orthogonal classifier according to the present invention, and FIGS. 7 and 8 are tables illustrating an example of training results of an artificial neural network including a fixed non-negative orthogonal classifier according to the present invention.

Meanwhile, as illustrated in FIG. 2, a classification device 1000 based on a fixed non-negative orthogonal classifier may include at least one of an input unit 100, a storage 200, or an artificial neural network 300.

Although not illustrated, the classification device 1000 based on a fixed non-negative orthogonal classifier may include one or more processors, and these processors may include one or more general-purpose processors and/or one or more specialized processors (for example, a digital signal processor, a tensor processing unit (TPU), a graphics processing unit (GPU), a neural network processing unit (NPU), an application-specific integrated circuit (ASIC), etc.). The one or more processors may be configured to execute instructions, computer-readable directives, and/or other instructions described in the present specification, which are stored (or included) in the storage 200. The classification device based on a fixed non-negative orthogonal classifier and a method thereof according to the present invention may perform data processing, as described below, with the cooperation of a memory and at least one processor. The processor may perform a series of operations and data processing using data and information stored in the memory. In this case, the memory may be a component of the input unit 100.

Meanwhile, the input unit 100 may serve as a means for data input, and may be configured in various types. For example, the input unit 100 may be configured to receive a user input. The input unit 100 may be configured to receive a user input from a user terminal. Here, the phrase “receives input” may mean receiving an input signal (or selection signal) corresponding to user input, based on input being made by a user through an input unit configuration provided in the user terminal. In the present invention, the input unit 100 does not necessarily refer to a hardware means, but may be understood as a channel for receiving input from a user.

The input unit 100 may also be referred to as a user interface module. The input unit 100 may include a touch screen, computer mouse, keyboard, keypad, touch pad, trackball, joystick, voice recognition module, or other similar devices. However, in the present invention, the types of the input unit 100 are not limited.

Here, the user input may include a document, text, image (or video), voice, and the like. In this case, the classification device 1000 based on a fixed non-negative orthogonal classifier may further include a module for converting voice into text.

Meanwhile, the storage 200 may perform a role of storing various data related to the present invention, and may include one or more non-transitory computer-readable storage media that may be read and/or accessed by at least one of the one or more processors.

The one or more computer-readable storage media may include volatile and/or non-volatile storage constituent elements, such as optical, magnetic, organic, or other memory or disk storage devices. In some examples, the storage 200 may be implemented using a single physical device (e.g., one optical, magnetic, organic, or other memory or disk storage device), whereas in other examples, the storage 200 may be implemented using two or more physical devices.

The storage 200 may include computer-readable directives and additional data. The storage 200 may include storage necessary to perform at least part of the methods, scenarios, and technologies described in this specification and/or at least part of the functions of the devices and networks.

Further, at least a part of the storage 200 may be a cloud storage or a cloud server. At least a part of data corresponding to user input received from the input unit 100 and training data may be stored in the storage 200.

That is, the storage 200 is sufficient to be a space where information necessary for the operation of the kinetic typography video generation system 1000 is stored, and it may be understood that there are no constraints on physical space.

Meanwhile, the neural network 300 may be configured to encode input data to extract a feature vector of each data, and to generate (or output) a final prediction value (or a class prediction value, a class probability value, a probability vector, etc.) for the input data using the extracted feature vector.

Specifically, the neural network 300 may be configured to include an encoder 310 that processes the input data to generate a feature vector, and a fixed non-negative orthogonal classifier 320 that receives the feature vector generated from the encoder 310 as input and outputs a final prediction value for the input data.

Here, examples of the data input to the neural network 300 may include at least one of image (or video) data, text data, voice data, time-series data (e.g., financial data, biometric signal data, etc.), sensor data (e.g., data on GPS, temperature, humidity, etc.), and structured data (e.g., data on table, graph, etc.).

However, in the present invention, the data input to the neural network 300 is not limited to any one of the above, and the data input to the neural network 300 may be determined according to the purpose or application of the classification device 1000 based on a fixed non-negative orthogonal classifier. For example, when the purpose of the classification device 1000 based on a fixed non-negative orthogonal classifier is “image classification and/or object detection,” in a training process, training data (or a training dataset) including at least one image (or video) may be input, and in an inference process, at least one image to be inferred (or analyzed) may be input.

Meanwhile, the fixed non-negative orthogonal classifier 320 is a classifier generated (or constructed) by adding non-negativity and orthogonality to a fixed classifier, and the fixed non-negative orthogonal classifier 320 may fix learned class vectors and be composed of a matrix in which all elements are non-negative, so that inter-class interference may be minimized through feature dimension separation.

Here, a class vector is a vector existing within the classifier, and may serve to generate a probability value for each class through an inner product operation with a feature vector.

In addition, the fixed non-negative orthogonal classifier 320 may be configured to satisfy a zero-mean neural collapse (ZNC) property (or characteristic). Zero-mean neural collapse is where a class mean is located centered at the origin rather than being the global mean of class vectors, which allows the mean between classes to be centered on the origin while maintaining the characteristics of neural collapse. Here, a class mean may refer to the average of feature vectors of all input data within a single class. For example, assuming that there are “1000” input images, the average vector of the feature vectors for the 1000 input images may be referred to as the “class mean” of the “dog class.” The average of such class means may be referred to as a global mean.

That is, the fixed non-negative orthogonal classifier 320 may be configured so that the center of each class mean extracted from the feature vectors, which are outputs of the encoder 310, is the origin rather than the global mean.

In an embodiment, as illustrated in FIG. 1, it can be seen that class vectors in the fixed non-negative orthogonal classifier 320 are spread equiangularly starting from the origin. This may improve learning (or classification) performance of the neural network by emphasizing orthogonality between classes and the center at the origin.

That is, the fixed non-negative orthogonal classifier 320 may induce zero-mean neural collapse by setting the class centers to be the origin, and unlike existing neural collapse, this may maintain equal distances between classes based on the origin instead of the global mean. The neural network 300 including such a fixed non-negative orthogonal classifier 320 may achieve overall optimization while satisfying zero-mean neural collapse, and during the training process, each class vector may be arranged and fixed in a specific form.

Meanwhile, the present invention is directed to providing a fixed non-negative orthogonal classifier in which non-negativity and orthogonality are added to a fixed classifier. More specifically, the present invention is to add non-negativity and orthogonality to a fixed classifier, explain neural collapse phenomena in a fixed classifier of a form other than a simplex equiangular tight frame, and improve performance in continual learning and imbalanced learning by enhancing Softmax masking using feature dimension separation and enabling implementation of arc-mixup. Hereinafter, a control method of a classification device based on a fixed non-negative orthogonal classifier, and a training method of the neural network 300 including the fixed non-negative orthogonal classifier 320 will be described in more detail.

Meanwhile, in the present invention, a process may proceed in which input data is processed as input to a neural network (S310, see FIG. 3), and a feature vector for the input data is acquired from an encoder of the neural network (S320, see FIG. 3).

As described above, the types of data received (or input) in the present invention may vary. In the present specification, for convenience of description, the description will be based on the assumption that an image (or video) is received as input data (or training data).

When an image is received from a user terminal, the classification device 1000 based on a fixed non-negative orthogonal classifier may process the received image as input to the neural network 300. The neural network 300 may input (or transmit) the received image to the encoder 310.

The encoder 310 of the neural network 300 may be configured to learn important patterns and information of the input data (or training data) and convert it into a feature vector in a high-dimensional space.

The encoder 310 may process the input image as input to a plurality of layers (e.g., a convolution layer, a pooling layer, a concatenation layer, etc.), and may gradually compress the input image and extract key features step by step. For example, in an initial convolution layer, low-level features such as edges or textures may be extracted, and as processing progresses to later layers, high-level features that recognize the shape or composition of an object may be extracted.

Further, in a final (or last) layer of the encoder 310, a feature vector for the image in a compressed form may be generated. In this case, the feature vector may be transformed into a form suitable for processing in the fixed non-negative orthogonal classifier 320 by making them have non-negativity through an activation function (or normalization layer), or may be used for classification tasks in the fixed non-negative orthogonal classifier 320.

Meanwhile, in the present invention, a process may proceed in which the feature vector is input to a fixed non-negative orthogonal classifier having non-negativity and orthogonality (S330, see FIG. 3), and a class probability value for the input data is acquired from the fixed non-negative orthogonal classifier (S340, see FIG. 3).

As described above, the fixed non-negative orthogonal classifier 320 is a classifier generated (or constructed) by adding non-negativity and orthogonality to a fixed classifier, and the fixed non-negative orthogonal classifier 320 may fix learned class vectors and be composed of a matrix in which all elements are non-negative, thereby serving to minimize inter-class interference through feature dimension separation.

Here, non-negativity may refer to a characteristic in which all elements of a matrix have values that are not negative (i.e., all elements of the matrix are equal to or greater than zero). More specifically, non-negativity may refer to a characteristic in which all elements (Qui) of a matrix (Q ∈ [symbol] ^{D×K}) have values that are not negative, as shown in [Equation 1] below.

$${Q}_{i , j} \underline{>} 0 , ∀ 1 \leq i \leq D , 1 \leq j \leq K \qquad [ Equation l ]$$

In the present invention, according to [Equation 1] above, a matrix (D×K) having the characteristic of non-negativity may be defined as in [Equation 2] below.

$$Q ∈ {ℝ}_{\geq 0}^{D \times K} \qquad [ Equation 2 ]$$

In addition, orthogonality may refer to a characteristic in which vectors of a matrix are orthogonal to each other such that their inner product becomes zero. More specifically, orthogonality may refer to a characteristic in which, as shown in [Equation 3] below, the matrix multiplication of a matrix (Q ∈ [symbol] ^{D×K}) and a transposed matrix (Q^{T} ∈ [symbol] ^{K×D}) of the matrix (or corresponding the matrix) results in an identity matrix (I_{K} ∈ [symbol] ^{K×K}).

$${Q}^{⊤} Q = {I}_{K} \qquad [ Equation 3 ]$$

In the present invention, the fixed non-negative orthogonal classifier 320 may be generated, as shown in the equation in section (a) of FIG. 6, by using vectors of a matrix that are orthogonal to each other and have non-negative values for all elements as class vectors, according to [Equation 2] and [Equation 3] above. That is, the fixed non-negative orthogonal classifier 320 may be composed of class vectors that are preset (or fixed) to satisfy non-negativity and orthogonality.

Meanwhile, a feature vector generated through the encoder 310 may be processed as input to the fixed non-negative orthogonal classifier 320.

The neural network 300 may transmit and process the feature vector acquired from the encoder 310 to the fixed non-negative orthogonal classifier 320. The fixed non-negative orthogonal classifier 320 may generate a class probability value (or probability vector) for each class of an input image from the feature vector. For example, a feature vector may be converted into a class-wise probability vector through matrix operations with the fixed non-negative orthogonal classifier 320.

A probability vector is a vector including class probability values (or prediction values) for each class of the input data, and each element of the probability vector may represent a probability value that the input data belongs to each class. For example, a probability vector for an input image represents the probability that a specific object in the image belongs to a specific class, and the higher the value represented by each element, the higher the possibility that the specific class belongs to the corresponding class. In this case, the elements of the probability vector may be represented as values between 0 and 1, and the sum of all the elements of the probability vector needs to satisfy 1. Such a probability vector may ultimately be used to determine (or specify) a final predicted class.

In this case, the fixed non-negative orthogonal classifier 320 may generate the probability vector through feature dimension separation.

Specifically, feature dimension separation may be a characteristic in which the elements of each class do not overlap in dimension with the elements of the remaining other class vectors with respect to preset class vectors. The feature dimension separation described in the present invention may refer to a characteristic in which, as shown in the equation in section (b) of FIG. 6, the elements of each class do not overlap in dimension with the elements of the remaining other class vectors with respect to all the class vectors.

In the equation shown in section (b) of FIG. 6, [symbol] ₖ may refer to the index of non-zero elements of the k-th class vector. Accordingly, when the equation shown in section (b) of FIG. 6 is satisfied, the dimensions in which the non-zero elements of a specific class vector exist do not overlap with the dimensions in which the non-zero elements of the remaining other class vectors exist, thereby reducing inter-class interference.

That is, according to the feature dimension separation of the fixed non-negative orthogonal classifier 320, the index set of a class weight vector does not intersect with the index set of another class weight vector. This means that elements of the features used for each class lose their usefulness for other classes, and each specific class has its own unique feature dimension, thereby minimizing inter-class interference. Such feature dimension separation may contribute to improving learning performance by preventing the features of a specific class from interfering with the learning of other classes.

Meanwhile, in the present invention, a process may proceed in which a final predicted class for input data is specified using a class probability value (S350, see FIG. 3).

As described above, each element of the probability vector may include a probability value that the input data belongs to each class. The classification device 1000 based on a fixed non-negative orthogonal classifier may specify a class index of the element having the highest value in the probability vector, by using the probability vector generated from the fixed non-negative orthogonal classifier 320, to determine the corresponding index as a final predicted class.

For example, it is assumed that the probability value of the probability vector is “[0.7, 0.2, 0.1]”. In this case, on the premise that the input data is an image, when it is assumed that the class corresponding to the value of 0.7 represents a lion, the class corresponding to the value of 0.2 represents a cat, and the class corresponding to the value of 0.1 represents a dog, the classification device 1000 based on a fixed non-negative orthogonal classifier may specify the class corresponding to the lion as a final predicted class, based on the fact that the class corresponding to the lion has the highest probability.

Meanwhile, the present invention is to enhance the Softmax masking effect by using the effect of the fixed non-negative orthogonal classifier 320 described above, and improve the performance of the model by alleviating the catastrophic forgetting phenomenon in continual learning. Hereinafter, with reference to the drawing attached in section (a) of FIG. 4 and the equation shown in section (c) of FIG. 6, a method and device for enhancing the Softmax masking effect using the fixed non-negative orthogonal classifier will be described in more detail.

Meanwhile, as illustrated in section (a) of FIG. 4, Softmax masking is a method used to alleviate interference from other classes in continual learning, and in the present invention, a mask (m^{(-∞)}), in which the k-th element is negative infinity (−∞), is generated as shown in [Equation 4] below, and this is multiplied by a feature vector (h), as shown in [Equation 5] below, and then a Softmax function is applied to generate a probability vector (p).

$${m}^{( - ∞ )} = {( {m}_{j} )}_{1 \leq j \leq K} \qquad [ Equation 4 ]$$

$$p = Softmax ( {m}^{( - ∞ )} ⊙ ( {W}^{⊤} h + b ) ) \qquad [ Equation 5 ]$$

In [Equation 5], K denotes the number of classes, and the element (mⱼ) of the mask (m^{(-∞)}) may have the value of negative infinity when j has the same value as k, and the value of 1 otherwise.

In addition, weighted Softmax is a method used together with a fixed classifier, and in the present invention, by learning a weight α that equalizes the magnitude of all class vectors, as shown in [Equation 6] below, it is possible to prevent inter-class interference caused by the magnitude difference among class vectors. Here, [Equation 4] and [Equation 5] above may also be expressed as the equation shown in section (c) of FIG. 6.

$$WeightedSoftnax ( z ) = α \times Softnax ( z ) \qquad [ Equation 6 ]$$

Further, in the present invention, as shown in [Equation 7] below, the inter-class interference alleviation effect may be enhanced by using weighted Softmax and the fixed non-negative orthogonal classifier 320 in the Softmax masking.

$$p = WeightedSoftnax ( {m}^{( - ∞ )} ⊙ ( {Q}^{⊤} h ) \qquad [ Equation 7 ]$$

Meanwhile, the method and device for enhancing the Softmax masking effect by using the fixed non-negative orthogonal classifier described above may also be implemented in the form of a training algorithm. In the present invention, this may be referred to as a first training algorithm (or first algorithm), and more detailed information on the first training algorithm will be described below.

As illustrated in section (b) of FIG. 4, the first training algorithm may also be understood as a training process (or method) for a specific (or t-th) task in continual learning using the fixed non-negative orthogonal classifier 320 and mask-weighted Softmax.

The first training algorithm according to the present invention may include at least one of [Equation 8], [Equation 9], [Equation 10], or [Equation 11].

$$H ← ReLU ( {f}_{θ} ( {X}_{t} ) ) \qquad [ Equation 8 ]$$

$$𝕂 = \{ {c}_{i} \vert {c}_{i} of {X}_{t} \} \qquad [ Equation 9 ]$$

$${M}^{( - ∞ )} = {( {m}_{j} )}_{1 \leq i \leq {N}_{t} , 1 \leq j \leq K} , where {m}_{i , j} = - ∞ if j ∉ 𝕂 otherwise 1 \qquad [ Equation 10 ]$$

$$P = WeightedSoftnax ( {M}^{( - ∞ )} ⊙ MatMul ( Q , H ) ) \qquad [ Equation 11 ]$$

According to [Equation 8] above, the neural network (300, ƒ_{θ}) may generate (or calculate) a feature vector H for training data (or input data (input sample), Xₜ) existing in a specific (t-th) task from the encoder 310.

Next, according to [Equation 9] above, the neural network 300 may generate (or define) a set (K) for class labels existing in the specific task.

Subsequently, in [Equation 10] above, Nₜ may refer to the number of training data existing in the t-th task, and K may refer to the number of total classes. [Equation 10] may be a process in which the neural network 300 calculates a mask matrix (M^{(-∞)}) for Softmax masking, and each element (m_{i,j}) of the mask matrix may have a specific value (e.g., “1”) when j is present in the set ( [symbol] ), and may have a negative infinity value when not present in the set ( [symbol] ).

Further, [Equation 11] may be a process in which a class probability value (confidence: meaning a probability value that the corresponding training data is classified into a specific class) for the training data is calculated from the feature vector (H), the mask matrix (M^{(-∞)}), and the fixed non-negative orthogonal classifier (320, Q), according to [Equation 8], [Equation 9], and [Equation 10] above. In this process, the neural network 300 may first perform matrix multiplication (MatMul) on the fixed non-negative orthogonal classifier (320, Q) and the feature vector (H), and then multiply the result by the mask matrix (M^{(-∞)}), thereby reducing interference from classes that do not exist in the t-th task. Finally, the neural network 300 may calculate a class probability value for the training data by applying weighted Softmax (WeightedSoftmax) to the masked value (M^{(-∞)} ⊙ MatMul (Q,H)).

In an embodiment, the neural network 300 pre-trained based on the first training algorithm, during an inference process, may extract a feature vector from received input data (Xₜ), generate a set (K) for class labels existing in a specific task, calculate a mask matrix (M^{(-∞)}) for Softmax masking based on the set of class labels, perform matrix multiplication on the fixed non-negative orthogonal classifier (320, Q) and the feature vector (H), and apply weighted Softmax to the masked value (M^{(-∞)}⊙ MatMul (Q, H)) to calculate a class probability value (P, or probability vector) for the input data. Then, the classification device 1000 based on a fixed non-negative orthogonal classifier may specify a final predicted class for the input data (e.g., in case of an image, the class to which a specific object included in the image belongs (lion, cat, dog, etc.)) by using the calculated probability value.

That is, the first training algorithm according to the present invention improves the performance of the neural network 300 in a continual learning environment by reducing interference from previous tasks, and supports more balanced training of the neural network 300 by suppressing the influence of specific classes in imbalanced learning. For example, with reference to the table illustrated in FIG. 7, it can be seen that as a result of training the neural network 300 using the first training algorithm according to the present invention, the training method using the first training algorithm and the fixed non-negative orthogonal classifier 320 according to the present invention shows overall higher performance compared to the method using a fixed classifier.

Meanwhile, the present invention enables implementation of arc-mixup, and by using this to reduce inter-class interference in imbalanced learning, improves the classification performance of the model. Hereinafter, with reference to the drawing attached in section (a) of FIG. 5 and the equation shown in section (d) of FIG. 6, a method and device for implementing arc-mixup using the fixed non-negative orthogonal classifier 320 will be described in more detail.

Arc-mixup may generate a mixed vector (\hat{q}) from two different class vectors through an interpolation-based augmentation method, as shown in [Equation 12] below.

$$\hat{q} = λ \cdot {q}_{i} + \sqrt{1 - {λ}^{2}} \cdot {q}_{j} \qquad [ Equation 12 ]$$

The mixed vector generated from arc-mixup has the same magnitude as a class vector, so the loss ( [symbol] _{cis}) value may be calculated without a Softmax function, as shown in [Equation 13] below (or see section (d) of FIG. 6).

(In this case, in the equation shown in section (d) of FIG. 6, xᵢ and xⱼ denote input vectors, and qᵢ and qⱼ denote class weight vectors. In addition, λ represents a mixing ratio, and this equation ensures that the vector is still located on a hypersphere.)

$${ℒ}_{cls} ( \hat{x} , \hat{q} ) = - log {\hat{q}}^{{}_{⊤}} \hat{h} \qquad [ Equation 13 ]$$

In [Equation 13], ĥ denotes the final layer feature of \hat{x}, which ensures that \hat{q} is still located on the hypersphere.

Meanwhile, according to batch-wise feature masking, unlike the conventional Softmax masking processing method, the neural network 300, based on batch-wise feature masking, may generate an index set ( [symbol] ) of non-zero elements in the class vectors of classes that do not exist in the batch, as shown in [Equation 14] below, and may generate a mask matrix (M⁽⁰⁾) for feature vectors of input samples (or training samples) in the batch using the index set ( [symbol] ), as shown in [Equation 15] below. Then, as shown in [Equation 16] below, the neural network 300 may multiply the mask matrix with the matrix (H) of layer-normalized feature vectors, and finally generate a matrix (P) of probability vectors through an inner product operation with the classifier (W).

$$\hat{𝕛} = {U}_{k ∈ 𝕂} {𝕁}_{k} , where 𝕂 = \{ {c}_{i} \vert {c}_{i} ∈ 𝔹 , ∀ 1 \leq i \leq \vert 𝔹 \vert \} \qquad [ Equation 14 ]$$

$${M}^{( 0 )} = {( {m}_{i , j} )}_{1 \leq i \leq \vert 𝔹 \vert , 1 \leq j \leq D} , where {m}_{i , j} = {1}_{j ∈ 𝕁} \qquad [ Equation 15 ]$$

$$p = InnerProduct ( \hat{q} , LayerNorm ( {m}^{( 0 )} ⊙ \hat{h} ) ) \qquad [ Equation 16 ]$$

In [Equation 14] above, cᵢ denotes class labels existing in the batch, and [symbol] may refer to a set of such class labels. In addition, in [Equation 15] above, D denotes the size of the feature vector, and an element (m_{i,j}) of the mask matrix (M⁽⁰⁾) may have a first value (e.g., “1”) when a specific index j is present in the index set ( [symbol] ), and a second value (e.g., “0”) when the specific index j is not present in the index set ( [symbol] ).

Meanwhile, the method and device for implementing arc-mixup using the fixed non-negative orthogonal classifier described above may also be implemented in the form of a training algorithm. In the present invention, this may be referred to as a second training algorithm (or second algorithm), and more detailed information on the second training algorithm will be described below.

As illustrated in section (b) of FIG. 5, the second training algorithm may also be understood as a training method at a mini-batch unit in imbalanced learning using the fixed non-negative orthogonal classifier 320, arc-mixup, and feature masking.

The second training algorithm according to the present invention may include at least one of [Equation 17], [Equation 18], [Equation 19], [Equation 20], [Equation 21], or [Equation 22] below.

$$( \hat{X} , \hat{Q} ) ← ArcMixup ( X , Q ) \qquad [ Equation 17 ]$$

$$\hat{H} ← ReLU ( {f}_{θ} ( \hat{X} ) ) \qquad [ Equation 18 ]$$

$$𝕂 = \{ {c}_{i} \vert {c}_{i} ∈ 𝔹 , ∀ 1 \leq i \leq \vert 𝔹 \vert \} \qquad [ Equation 19 ]$$

$$\hat{𝕁} = {U}_{k ∈ 𝕂} {𝕁}_{k} \qquad [ Equation 20 ]$$

$${M}^{( 0 )} = {( {m}_{i , j} )}_{1 \leq i \leq \vert 𝔹 \vert , 1 \leq j \leq D} , where {m}_{i , j} = {1}_{j ∈ 𝕁} \qquad [ Equation 21 ]$$

$$P = MatMul ( \hat{Q} , LayerNorm ( {M}^{( 0 )} ⊙ \hat{H} ) ) \qquad [ Equation 22 ]$$

According to [Equation 17] above, the neural network 300 may generate a mixed vector, \hat{X}, and \hat{Q} respectively through arc-mixup, from training data (or input data) existing in a mini-batch, and class vectors for (or corresponding to, matched to, etc.) the training data. The detailed process of arc-mixup is shown in [Equation 23] and [Equation 24] below (or see section (d) of FIG. 6).

$$\tilde{X} = λ \cdot {X}_{i} + \sqrt{1 - {λ}^{2}} \cdot {X}_{j} \qquad [ Equation 23 ]$$

$$\hat{Q} = λ \cdot {Q}_{i} + \sqrt{1 - {λ}^{2}} \cdot {Q}_{j} \qquad [ Equation 24 ]$$

In addition, according to [Equation 18] above, the neural network 300 may generate a feature vector (Ĥ) for a mixed vector, from the mixed vector (\hat{X}) generated through arc-mixup.

Further, according to [Equation 19] above, the neural network 300 may generate (or define) a set ( [symbol] ) of class labels existing in the mini-batch.

Subsequently, [Equation 20] above may be a process in which the neural network 300 generates (or defines) a total index set ( [symbol] ), and this may be generated from a union operation of index sets ( [symbol] ₖ) of non-zero elements of the k-th class vectors.

Further, [Equation 21] may be a process in which the neural network 300 calculates a mask matrix (M⁽⁰⁾), and the mask matrix may be generated based on an index set of the elements where values of the class vectors in the mini-batch exist, through batch-wise feature masking.

More specifically, an element (m_{i,j}) of the mask matrix (M⁽⁰⁾) may have a first value (e.g., “1”) when a specific index j is present in the index set ( [symbol] ), and may have a second value (e.g., “0”) when the specific index j is not present in the index set ( [symbol] ).

Furthermore, [Equation 22] may be a process in which a class probability value (confidence: meaning a probability value that the corresponding training data is classified into a specific class) for training data is calculated using a feature vector (Ĥ), the fixed non-negative orthogonal classifier (320, \hat{Q}) and the mask matrix (M⁽⁰⁾).

Here, the class probability value may be calculated by using at least one of the fixed non-negative orthogonal classifier (320, \hat{Q}) the mask matrix (M⁽⁰⁾), the mixed vector, and the feature vector (Ĥ) for the mixed vector.

In this process, the neural network 300 may first multiply the feature vector (Ĥ) by the mask matrix (M⁽⁰⁾) to reduce interference from the parts corresponding to the classes that do not exist in the mini-batch. Then, by performing a matrix multiplication (MatMul) with the fixed non-negative orthogonal classifier (320, \hat{Q}) on the multiplied value, a class probability value (P) for the training data may be calculated.

That is, the class probability value (P) may be calculated by multiplying a feature vector (Ĥ) by a mask matrix (M⁽⁰⁾), and then performing matrix multiplication with the fixed non-negative orthogonal classifier (320, \hat{Q}) on the multiplied value.

Finally, the classification device 1000 based on a fixed non-negative orthogonal classifier may define a loss function from the class probability value (P) for the training data. The loss function may be defined as in [Equation 25] below.

$${ℒ}_{cls} ( \hat{X} , \hat{Q} ) = - log P \qquad [ Equation 25 ]$$

The artificial neural network 300 may be trained using the loss function defined in [Equation 25]. For example, the classification device 1000 based on a fixed non-negative orthogonal classifier may calculate a loss between the ground-truth class for the training data and the class probability value generated by the fixed non-negative orthogonal classifier 320, using the loss function, and may perform training on the neural network 300 such that the loss becomes smaller.

In an embodiment, the neural network 300 pre-trained based on the second training algorithm, in an inference process, may generate a mixed vector through arc-mixup from input data existing in the mini-batch and class vectors for the input data, may generate a feature vector (Ĥ) for a mixed vector, from the mixed vector (\hat{X}) generated through arc-mixup, may generate a mask matrix (M⁽⁰⁾) based on an index set ( [symbol] ) for the elements where values of the class vectors in the mini-batch exist, through batch-wise feature masking, and may calculate a class probability value (P) for the input data by performing matrix multiplication with the fixed non-negative orthogonal classifier (320, \hat{Q}) on the value obtained by multiplying the feature vector (Ĥ) by the mask matrix (M⁽⁰⁾). Then, the classification device 1000 based on a fixed non-negative orthogonal classifier may specify a final predicted class for the input data (e.g., in case of an image, the class to which a specific object included in the image belongs (lion, cat, dog, etc.)) by using the calculated probability value.

That is, the second training algorithm according to the present invention may reduce inter-class interference and may allow the neural network 300 to effectively learn inter-class boundaries even in an imbalanced learning environment. For example, with reference to the table illustrated in FIG. 8, as a result of the training of the neural network 300 using the second training algorithm according to the present invention, it can be seen that the training method combining arc-mixup and the fixed non-negative orthogonal classifier 320 shows overall higher performance compared to other methods.

As described above, the neural network 300 may be trained using a class probability value for training data (or input data), calculated through at least one training algorithm (the first training algorithm or the second training algorithm) defined based on the fixed non-negative orthogonal classifier.

Meanwhile, as described above, according to the classification device based on the fixed non-negative orthogonal classifier and control method thereof according to the present invention, it is possible to alleviate inter-class interference by generating a feature dimension separation phenomenon through a fixed non-negative orthogonal classifier in which non-negativity and orthogonality are added.

In addition, according to the classification device based on the fixed non-negative orthogonal classifier and control method thereof according to the present invention, Softmax masking using the fixed non-negative orthogonal classifier may improve the training performance of a model (or neural network) in continual learning by weakening the catastrophic forgetting effect.

Further, according to the classification device based on the fixed non-negative orthogonal classifier and control method thereof according to the present invention, the application of arc-mixup and mini-batch unit masking using the fixed non-negative orthogonal classifier may improve the performance of a model (or neural network) in imbalanced learning by alleviating inter-class interference and reinforcing balanced decision boundary learning. This may contribute to enabling the model to efficiently learn more balanced decision boundaries in an imbalanced dataset.

Further, the classification device 1000 based on a fixed non-negative orthogonal classifier according to the present invention may be implemented through a computing device described below, and may perform data processing related to the control method of the classification device based on a fixed non-negative orthogonal classifier as described above.

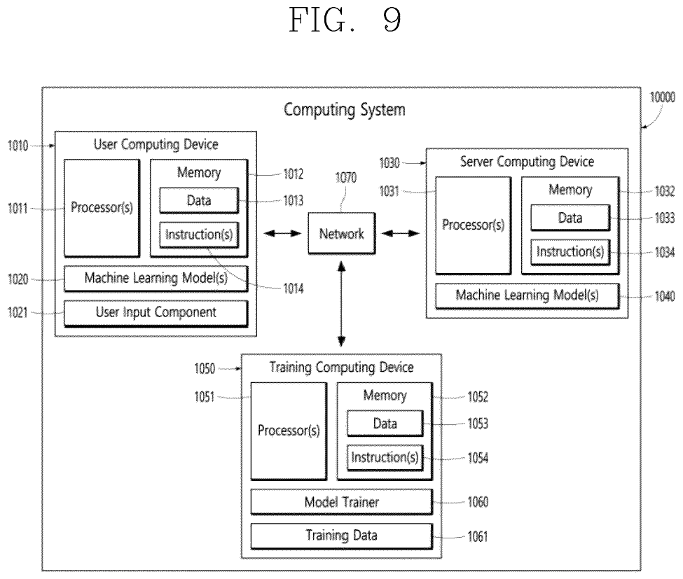

FIG. 9 illustrates an example block diagram of a computing system in which the present invention may be implemented.

Referring to FIG. 9, a computing system (10000) for performing a control method of a positive orthogonal fixed classifier-based classification device according to an embodiment of the present invention may include at least one computing device. In this case, the at least one computing device may be a single-processor or multi-processor computing apparatus.

The components of the at least one computing device of the present invention may include one or more processors, memory, other hardware, and various system components connected (e.g., communicatively, physically, or electrically connected) via a system bus (not shown) that enables data to be transmitted and received among them. The components of the at least one computing device are not limited thereto and may vary widely.

Meanwhile, the at least one computing device included in the computing system (10000) for performing the control method of a positive orthogonal fixed classifier-based classification device may be communicatively connected via a network (1070). For example, the at least one computing device included in the computing system (10000) may be clustered or may be part of a local area network (LAN). Additionally, the at least one computing device may be part of a wide area network (WAN) or may be connected via at least one of a client-server network or a peer-to-peer network within a cloud environment.

Meanwhile, when the at least one computing device is used in at least one environment among a network environment and a cloud computing environment, the at least one computing device may be connected to at least one of a public network and a private network through a network interface or adapter. In one embodiment, other communication connection devices, such as a modem, may be used to establish communication over the network. The modem may be at least one of an internal modem and an external modem, and may be connected to the system bus through a network interface or a specific mechanism. A wireless network component comprising an interface and an antenna may be coupled to the network through devices such as access points or peer computers. In the present invention, the method by which the at least one computing device is communicatively connected via the network (1070) is not limited thereto and may be implemented by means other than the examples described above.

Furthermore, other computer-type devices and/or systems not illustrated in FIG. 9 may technically interact with the at least one computing device or other systems through one or more connections to the network (1070) via a network interface. Here, the network interface may include network interface equipment such as a physical Network Interface Controller (NIC) or a Virtual Interface (VIF).

The network (1070) of the present invention may include various types of networks such as the Internet, Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), High Speed Uplink Packet Access (HSUPA), Long Term Evolution (LTE), Long Term Evolution-Advanced (LTE-A), 5th Generation Mobile Telecommunication (5G), Bluetooth™, Radio Frequency Identification (RFID), Infrared Data Association (IrDA), Ultra-Wideband (UWB), ZigBee, Near Field Communication (NFC), Wireless Universal Serial Bus (Wireless USB), and the like. In the present invention, data transmission may be performed based on standard communication protocols such as TCP/IP, HTTP, SSL, and others.

The computing system (10000) for performing the control method of a positive orthogonal fixed classifier-based classification device according to the present invention may include at least one of a user computing device (1010), a training computing device (1050), and a server computing device (1030).

The user computing device (1010) according to the present invention may be understood as a computing device including at least one processor (1011) and memory (1012) for performing the control method of a positive orthogonal fixed classifier-based classification device. For example, the user computing device (1010) may include at least one computing device selected from among a smart phone, smart TV, laptop computer, desktop computer, digital broadcasting terminal, personal digital assistant (PDA), portable multimedia player (PMP), navigation device, slate PC, tablet PC, ultrabook, and wearable device (e.g., smartwatch, smart glass, and head-mounted display (HMD)).

The at least one processor (1011) constituting the user computing device (1010) may include one or more general-purpose processors and/or one or more special-purpose processors. For example, the at least one processor (1011) of the user computing device (1010) may include at least one or a combination of electrically connected processors selected from the group consisting of: a Central Processing Unit (CPU), a Graphics Processing Unit (GPU), a Tensor Processing Unit (TPU), a Neural Processing Unit (NPU), an Arithmetic Logic Unit (ALU), a Floating Point Unit (FPU), an Application-Specific Integrated Circuit (ASIC), a digital signal processing device (DSPD), a programmable logic device (PLD), a Field Programmable Gate Array (FPGA), a controller, a microcontroller, a microprocessor, and other electrical units for performing specific functions.

Furthermore, the at least one processor (1011) may be configured to execute computer-readable instructions stored in the memory (1012) and/or other commands described in the present specification.

The memory (1012) constituting the user computing device (1010) according to the present invention may include volatile memory, non-volatile memory, fixed media, removable media, magnetic media, optical media, semiconductor media, and/or other types of physically durable storage media.

For example, the memory (1012) may include one or more non-transitory/transitory computer-readable storage media, or combinations thereof, such as Random Access Memory (RAM), Read Only Memory (ROM), Hard Disk Drive (HDD), Solid State Disk (SSD), Silicon Disk Drive (SDD), Electrically Erasable Programmable Read-Only Memory (EEPROM), Erasable Programmable Read-Only Memory (EPROM), flash memory devices, and magnetic disks. It may also include web storage of a server that performs the memory storage function over the Internet.

The memory (1012) may store data and instructions necessary for the at least one processor (1011) to perform operations of an application for controlling a positive orthogonal fixed classifier-based classification device.

The user computing device (1010) may include one or more user input components (1021) configured to detect user input. For example, the user input component (1021) may also be referred to as a user interface module. The user input component (1021) may include devices such as a touchscreen, computer mouse, keyboard, keypad, touchpad, trackball, joystick, voice recognition module, or other similar devices. However, the present invention does not limit the types of the user input component (1021).

In this context, the user input component (1021) in the present invention is not necessarily limited to a hardware means but may be understood as a channel through which input is received from a user.

Meanwhile, the “user” in the present invention may also refer to an automated agent, script, playback software, or the like that operates on behalf of one or more human users.

A user may interact with the computing system (10000), which includes at least one computing device, through the user input component (1021) using inputted text, touch, voice, motion, computer vision, gesture, and/or other forms of input/output. For example, the user input component (1021) may include one or more user interface (UI) modalities such as a Command Line Interface (CLI), Graphical User Interface (GUI), Natural User Interface (NUI), voice command interface, and/or other UI representations.

One or more Application Programming Interface (API) calls may be made between the user input component (1021) and the user computing device (1010), based on user input received through a user interface and/or from a network.

Herein, the phrase “based on” may be interpreted to include instances where a particular configuration is used as a foundation, modified from, derived from, influenced by, dependent on, or otherwise originating from such configuration.

In some embodiments, the API call may be configured for a specific API and may be interpreted as, or converted into, an API call configured for a different API. In this context, the API may refer to a defined interface or connection between computers or between computer programs.

In one embodiment, the user computing device (1010) may store one or more machine learning models (1020). For example, the user computing device (1010) may include various machine learning models, such as multiple neural networks (e.g., deep neural networks) for controlling a positive orthogonal fixed classifier-based classification device, or other types of machine learning models including nonlinear models and/or linear models or may be configured as a combination thereof.

According to an embodiment of the present invention, the user computing device (1010) may perform a control method of a positive orthogonal fixed classifier-based classification device by using a local and/or external machine learning model (1020). Alternatively, the user computing device (1010) may perform the control method of a positive orthogonal fixed classifier-based classification device by using a machine learning model (1040) provided by a server.

According to another embodiment of the present invention, a server computing device (1030) communicating with the user computing device (1010) may provide a final predicted class for input data to the user computing device (1010) via an application and/or a web interface, in response to a user request received through the user computing device (1010).

According to yet another embodiment of the present invention, at least a portion of the user computing device (1010) and the server computing device (1030) may be cooperatively operated to perform a control method of a positive orthogonal fixed classifier-based classification device, thereby providing a final predicted class for input data to the user.

According to various embodiments of the present invention, the user computing device (1010) and/or the server computing device (1030) may train the machine learning models (1020, 1040) used in the control method of a positive orthogonal fixed classifier-based classification device through interaction with a training computing device (1050) that is communicatively connected via the network (1070).

In this case, the training computing device (1050) may be a computing system separate from the server computing device (1030). Alternatively, in some embodiments, the training computing device (1050) may be a part of the server computing device (1030) or a part of the user computing device (1010).

Meanwhile, the server computing device (1030) may include at least one processor (1031) and memory (1032). Here, the processor (1031) may include at least one or a combination of electrically connected processors selected from among: a Central Processing Unit (CPU), Graphics Processing Unit (GPU), Tensor Processing Unit (TPU), Neural Processing Unit (NPU), Application-Specific Integrated Circuit (ASIC), Arithmetic Logic Unit (ALU), Floating Point Unit (FPU), digital signal processing devices (DSPDs), programmable logic devices (PLDs), Field Programmable Gate Arrays (FPGAs), controllers, microcontrollers, microprocessors, and/or other electrical units for performing specific functions. For example, the at least one processor (1031) may include circuits and transistors configured to execute instructions from the memory (1032).

The memory (1032) constituting the server computing device (1030) according to the present invention may include volatile memory, non-volatile memory, fixed media, removable media, magnetic media, optical media, semiconductor media, and/or other types of physically durable storage media.

For example, the memory (1032) may include one or more transitory/non-transitory computer-readable storage media, or combinations thereof, such as Random Access Memory (RAM), Read Only Memory (ROM), Hard Disk Drive (HDD), Solid State Disk (SSD), Silicon Disk Drive (SDD), Electrically Erasable Programmable Read-Only Memory (EEPROM), Erasable Programmable Read-Only Memory (EPROM), flash memory devices, and magnetic disks. It may also include web storage of a server that performs memory storage functions over the Internet.

Additionally, the server computing device (1030) may further include a data store. For example, the data store may be configured as at least one of a relational database, a NoSQL database, a data warehouse, and a local file system.

The memory (1032) constituting the server computing device (1030) according to the present invention may store data and instructions necessary for the at least one processor (1031) to perform operations of an application for controlling a positive orthogonal fixed classifier-based classification device.

In one embodiment, the server computing device (1030) may be configured as a single device or as a plurality of computing devices, which may be configured to operate according to a sequential or parallel computing architecture. Additionally, the system may be implemented as a distributed processing system comprising multiple devices connected over a network.

Meanwhile, the training computing device (1050) may include at least one processor (1051) and memory (1052). A model trainer (1060), as a logical component that performs training of at least one machine learning model (1020, 1040), may be implemented in the form of hardware, firmware, or software.

For example, the model trainer (1060) may load training data (1061) stored in a storage device into the memory (1052), and then be executed by the processor (1051). The model trainer (1060) may be configured to perform one or more operations-such as model training, model reconstruction, model validation, and model testing-on at least one machine learning model.

The machine learning model according to the present invention may include at least one of the following: a statistical model, an algorithm, a neural network (NN), a convolutional neural network (CNN), a generative neural network (GNN), a Word2Vec model, a Bag of Words model, a Term Frequency-Inverse Document Frequency (TF-IDF) model, a Generative Pre-trained Transformer (GPT) model (or other autoregressive models), a Proximal Policy Optimization (PPO) model, a nearest neighbor model (e.g., k-nearest neighbor model), a linear regression model, a k-means clustering model, a Q-learning model, a Temporal Difference (TD) model, a Deep Adversarial Network model, and any other type of model described in the present specification.

Specifically, the model trainer (1060) may perform operations for training a machine learning model, and the operations may include at least one of adding, removing, and modifying model parameters. In this case, the training of the machine learning model may be at least one of supervised learning, semi-supervised learning, and unsupervised learning.

In one embodiment, training of the machine learning model may include a step of repeatedly inputting the training data (1061) based on epochs, and iteratively performing the machine learning model training process configured in this manner. Here, an epoch may refer to a unit representing one complete forward and backward pass of the entire training data (1061) set.

In some implementations, different learning methods (e.g., supervised learning, semi-supervised learning, and unsupervised learning) may be applied at different epochs.

The training data (1061) of the present invention may include input data and/or data previously output from at least one machine learning model (e.g., recursive learning feedback).

The parameters of the at least one machine learning model may include at least one of a seed value, model nodes, model layers, algorithms, functions, connections between different machine learning models, connections between parameters, constraints of the machine learning model, and other digital components that influence the output of the machine learning model.

In this case, a model connection between different machine learning models may include or represent relationships between model parameters and/or between models, which may be dependent, interdependent, hierarchical, and/or static or dynamic.

The combination and configuration of the model parameters described herein may be too complex to be maintained or utilized by human cognitive capabilities.

The present invention does not limit the parameters of machine learning models to those described in the embodiments, and a single machine learning model may include a plurality of model parameters.

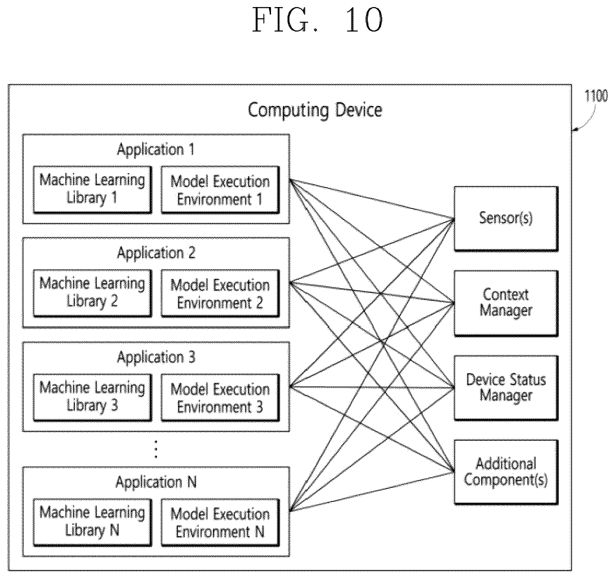

Meanwhile, FIG. 10 illustrates an example block diagram of a computing device (1100), which may be included in the user computing device (1010), the server computing device (1030), or the training computing device (1050), as one embodiment of the computing system (10000) in which the present invention may be implemented.

As shown in FIG. 10, the computing device (1100) may include at least one application (e.g., Application 1 to Application N), and each of the at least one application may include a machine learning library and a model execution environment for performing a control method of a positive orthogonal fixed classifier-based classification device using machine learning.

Each of the at least one application included in the computing device (1100) may communicate via an Application Programming Interface (API) with one or more components within the computing device (1100), such as sensors, a context manager, a device state manager, or additional components.

In one embodiment, the at least one application may interface with device components by, for example, receiving sensor data or state data via a public or dedicated API, or transmitting prediction results to an output device.

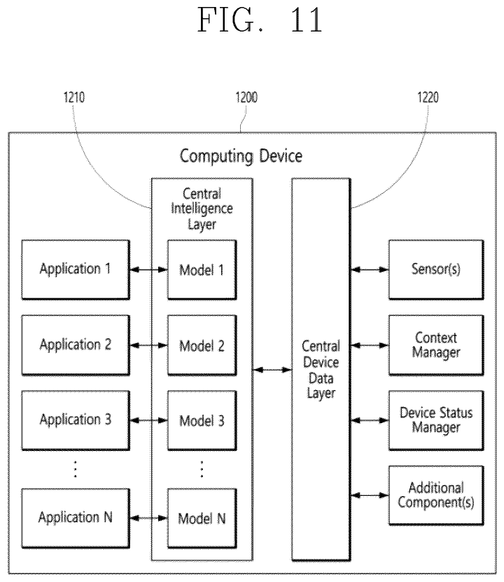

Meanwhile, FIG. 11 illustrates an example block diagram of a computing device (1200), which is one component of the computing system (10000) performing the control method of a positive orthogonal fixed classifier-based classification device according to an embodiment of the present invention, from another perspective.

The computing device (1200) according to the present invention may include at least one application (e.g., Application 1 to Application N), and each of the at least one application may communicate with a central intelligence layer (1210). Each application may interact with a shared model within the central intelligence layer (1210) via an API (e.g., a common API).

The central intelligence layer (1210) may include one or more machine learning models and may either share them among multiple applications or provide them independently to each application. In one embodiment, the central intelligence layer (1210) may be integrated as part of the operating system or implemented as a separate logical layer.

Additionally, the central intelligence layer (1210) may communicate with a central device data layer (1220). The central device data layer (1220) may integratively store input images stored within the computing device (1200) and provide them as input data required for controlling a positive orthogonal fixed classifier-based classification device. Each device component (e.g., sensors, state managers, etc.) may communicate with the central device data layer (1220) via a private API or the like.

The technology described in the present specification may be implemented using a single computing device or multiple computing devices. A machine learning model for performing a control method of a positive orthogonal fixed classifier-based classification device may be executed sequentially or in parallel on a single component or across multiple distributed components. The data store, machine learning models, and applications may be distributed and operated locally or over a network, and these components may be flexibly applied to various system architectures.

The above has described the implementation of the classification device 1000 based on a fixed non-negative orthogonal classifier of the present invention as a computing system, but the present invention is not limited thereto. For example, the functionality of the neural network and/or computing device may be distributed among a plurality of computing clusters.

Meanwhile, the present invention described above may be executed by one or more processes on a computer and implemented as a program that may be stored on a computer-readable medium (or recording medium).

Further, the present invention described above may be implemented as computer-readable code or instructions on a medium in which a program is recorded. That is, the present invention may be provided in the form of a program.

Meanwhile, the computer-readable medium includes all kinds of recording devices for storing data readable by a computer system. Examples of computer-readable media include hard disk drives (HDDs), solid state disks (SSDs), silicon disk drives (SDDs), ROMs, RAMs, CD-ROMs, magnetic tapes, floppy discs, and optical data storage devices.

Further, the computer-readable medium may be a server or cloud storage that includes storage and that the electronic device is accessible through communication. In this case, the computer may download the program according to the present invention from the server or cloud storage, through wired or wireless communication.

Further, in the present invention, the computer described above is an electronic device equipped with a processor, that is, a central processing unit (CPU), and is not particularly limited to any type.

Meanwhile, it should be appreciated that the detailed description is interpreted as being illustrative in every sense, not restrictive. The scope of the present invention should be determined on the basis of the reasonable interpretation of the appended claims, and all of the modifications within the equivalent scope of the present invention belong to the scope of the present invention.

What is claimed is:

1. A control method of a classification device based on a fixed non-negative orthogonal classifier, the control method processed by a computing device comprising:
processing input data as an input of a neural network;
acquiring a feature vector for the input data from an encoder of the neural network;
inputting the feature vector to a fixed non-negative orthogonal classifier having non-negativity and orthogonality;
acquiring a class probability value for the input data from the fixed non-negative orthogonal classifier; and
specifying a final predicted class for the input data by using the class probability value.

2. The control method of claim 1, wherein the fixed non-negative orthogonal classifier has the non-negativity, in which all elements of a matrix have non-negative values, and the orthogonality, in which a matrix multiplication of the matrix and a transposed matrix of the matrix is an identity matrix.

3. The control method of claim 2, wherein the fixed non-negative orthogonal classifier is composed of class vectors that are preset to satisfy the non-negativity and the orthogonality.

4. The control method of claim 3, wherein the acquiring of the class probability value comprises:
predicting the class probability value through feature dimension separation of the fixed non-negative orthogonal classifier; and
acquiring the class probability value predicted from the fixed non-negative orthogonal classifier.

5. The control method of claim 4, wherein the feature dimension separation is a characteristic in which elements of each class do not overlap in dimension with elements of remaining other class vectors, with respect to the preset class vectors.

6. The control method of claim 5, wherein the fixed non-negative orthogonal classifier satisfies a zero-mean neural collapse (ZNC), and sets a center of the class vectors to an origin instead of a mean of each class.

7. The control method of claim 1, wherein the neural network performs training by using at least one training algorithm defined based on the fixed non-negative orthogonal classifier.

8. The control method of claim 7, wherein the neural network performs training by using a loss function defined from the class probability value.

9. A classification device based on a fixed non-negative orthogonal classifier, the classification device comprising:
a memory and at least one processor,
wherein the memory and the processor cooperate to:
process input data as an input to a neural network;
acquire a feature vector for the input data from an encoder of the neural network;
input the feature vector to a fixed non-negative orthogonal classifier having non-negativity and orthogonality;
acquire a class probability value for the input data from the fixed non-negative orthogonal classifier; and
specify a final predicted class for the input data by using the class probability value.

10. The classification device of claim 9,
wherein the fixed non-negative orthogonal classifier has the non-negativity, in which all elements of a matrix have non-negative values, and the orthogonality, in which a matrix multiplication of the matrix and a transposed matrix of the matrix is an identity matrix.

11. The classification device of claim 10,
wherein the fixed non-negative orthogonal classifier is composed of class vectors that are preset to satisfy the non-negativity and the orthogonality.

12. The classification device of claim 11,
wherein the memory and the processor cooperate to acquire the class probability value by:
predicting the class probability value through feature dimension separation of the fixed non-negative orthogonal classifier; and
acquiring the class probability value predicted from the fixed non-negative orthogonal classifier.

13. The classification device of claim 12,
wherein the feature dimension separation is a characteristic in which elements of each class do not overlap in dimension with elements of remaining other class vectors, with respect to the preset class vectors.

14. The classification device of claim 13,
wherein the fixed non-negative orthogonal classifier satisfies a zero-mean neural collapse (ZNC), and sets a center of the class vectors to an origin instead of a mean of each class.

15. A program stored in a non-transitory computer-readable storage medium, executed by one or more processes in an electronic device, wherein the program includes instructions to perform:
processing input data as an input to a neural network;
acquiring a feature vector for the input data from an encoder of the neural network;
inputting the feature vector to a fixed non-negative orthogonal classifier having non-negativity and orthogonality;
acquiring a class probability value for the input data from the fixed non-negative orthogonal classifier; and
specifying a final predicted class for the input data by using the class probability value.

16. The non-transitory computer-readable storage medium of claim 15,
wherein the instructions, when executed by one or more processors, cause the one or more processors to utilize the fixed non-negative orthogonal classifier having the non-negativity, in which all elements of a matrix have non-negative values, and the orthogonality, in which a matrix multiplication of the matrix and a transposed matrix of the matrix is an identity matrix.

17. The non-transitory computer-readable storage medium of claim 16,
wherein the instructions, when executed by one or more processors, cause the one or more processors to utilize the fixed non-negative orthogonal classifier composed of class vectors that are preset to satisfy the non-negativity and the orthogonality.

18. The non-transitory computer-readable storage medium of claim 17,
wherein the instructions, when executed by one or more processors, cause the one or more processors to acquire the class probability value by:
predicting the class probability value through feature dimension separation of the fixed non-negative orthogonal classifier; and
acquiring the class probability value predicted from the fixed non-negative orthogonal classifier.

19. The non-transitory computer-readable storage medium of claim 18,
wherein the instructions, when executed by one or more processors, cause the one or more processors to utilize the feature dimension separation as a characteristic in which elements of each class do not overlap in dimension with elements of remaining other class vectors, with respect to the preset class vectors.

20. The non-transitory computer-readable storage medium of claim 19,
wherein the instructions, when executed by one or more processors, cause the one or more processors to utilize the fixed non-negative orthogonal classifier that satisfies a zero-mean neural collapse (ZNC), and to set a center of the class vectors to an origin instead of a mean of each class.
